(19) United States
(12) Patent Application Publication
(10) Pub. No.: US 2018/0184618 A1
(43) Pub. Date: Jul. 5, 2018

(54) INVISIBLE LEASH SYSTEM

(71) Applicant: Gregory G. Gotts, Oakland, CA (US)

(72) Inventor: Gregory G. Gotts, Oakland, CA (US)

(21) Appl. No.: 15/396,621

(22) Filed: Dec. 31, 2016

(51) Int. Cl. A01K 15/02; A01K 27/00; A01K 11/00; G08B 21/02

(52) U.S. Cl. CPC A01K 15/023; A01K 27/009; A01K 27/001; H04L 67/306; G08B 21/0266; G08B 21/0277; A01K 11/008

(57) ABSTRACT

An invisible leash electronic dog collar system and mobile device user interface for training a pet dog to stay within a user-defined space, distance or radius from the user, or predetermined home space or local area map. Additional configuration settings and functionality is provided through a mobile device or smartphone application based user interface. An electronic dog collar or collar attachment is provided for the dog with electrical, vibrational, mechanical, and audible stimulus modalities. A mobile device or smartphone based application is provided for the dog owner to configure and adjust settings and functionality of the dog collar. The mobile device application user interface allows setting the maximum allowable defined distance or radius the dog is able to travel away from the owner or other defined location point. Multiple dogs may be trained and controlled with the system. Variable stimulus intensities and modalities are configured in the user interface menu for delivery to the dog by the electronic collar in response to the dog's location from the owner. The owner may alternatively define through the user interface a home space or local area map to which the dog is to be confined and set the type of stimulus intensity and modality to be used to confine the dog. Additionally, the user interface allows the dog owner to train and condition the dog to understand the stimulus provided by the electronic collar.

### BACKGROUND

There are systems available for training and obedience management of pet dogs through the use of electronic collars which produce electrical, vibrational or other stimulus to reinforce good behavior, discourage bad behavior, and prevent movement beyond an acceptable area and keep the dog confined to a safe space. Current and previous methods for electronic invisible fence systems are established though physical antenna or cabling to define the dog's confinement area. Upon leaving the area boundary, an electrical shock or vibrational stimulus is trigged and applied to the dog through the receiver and electronic collar worn by the animal. There are also available systems which utilize GPS signals or centrally located radio frequency (RF) antenna to establish the electronic fence boundaries. However, at this time GPS signals and conventional RF signal technology do not provide enough accuracy and resolution to define a local area and boundaries with enough accuracy. Current GPS technology is only accurate to within 7.8 meters. In applying GPS signals to an electronic fence application, the result is a not well-defined boundary area and poor user experience. Furthermore, GPS signals do not work indoors. Alternative technologies are available to provide better accuracy for determining the local area and boundaries but have not yet been utilized in the application of solving the problem of pet dog confinement.

With electronic dog collar training systems, the dog owner provides the trigger via a hand held transmitter and activates the electrical or vibrational stimulus on the dog collar receiver. The use of an electronic dog collar receiver and a separate hand held transmitter is well known in current and previous methods for dog training and obedience. For example there are many currently available electronic dog collars which are manipulated with proprietary or dedicated hand held transmitters. Following the trend of future technology around networked devices, home automation, and the internet of things, the making of dedicated remotes and transmitters will be replaced with standardized network and internet protocols and cloud or mobile based user interfaces that do not require additional hardware beyond a smartphone, mobile device, or desktop computer. In other words, most hardware devices, such as an electronic dog collar, will be connected to the network and controlled with existing mobile devices or desktop computers and will not require a separate hand held transmitter. The dog owner should not have to carry additional hardware beyond an electronic collar and a mobile device or smartphone.

In using an electronic dog collar to control or confine a pet dog to a predetermined area, the owner must train the dog to understand the stimulus provided by the device. It is well known that dogs learn through repetition and from the ability to learn patterns and routines. Pavlov demonstrated through classical conditioning that a dog can be conditioned to produce a certain response to a presented stimulus. B. F. Skinner developed operant conditioning and this type of learning is used by dog trainers in reinforcing good behavior with a reward, such as a treat, and discouraging bad behavior with punishment. Therefore, the dog owner must condition the dog to understand the link between bad behavior and the use of an electronic collar in providing a negative stimulus, such as an electric shock or vibration. Repetitive training and conditioning with an electronic collar must be accomplished before any meaningful benefits are expected.

It is the aim of the present invention to address the shortcomings with current GPS and conventional RF signal technology; to provide a method for training a pet dog to stay within a defined radius, home space, or local area map with an invisible leash electronic dog collar; to provide a mobile device user interface to the collar; and to provide a method for training and conditioning the dog. The present system defines the area to confine the dog with local or indoor positioning system technology which provides more accuracy and resolution over GPS. The system allows mobile device or smartphone wireless connectivity with an electronic dog collar to eliminate the need for a separate hand held transmitter device. The electronic dog collar invisible leash system provides a mobile device or smartphone based application user interface with available menus and settings. Additionally, the user interface allows the dog owner to train and condition the dog to understand stimulus provided by the electronic collar.

### SUMMARY

An electronic dog collar invisible leash system with Wi-Fi, Bluetooth, or other network connectivity is provided for tracking and controlling a dog's movement to a predefined radius, home space, or local area map. The electronic dog collar invisible leash system device may be embodied in a dog collar with an electronic module or as an attachment to an existing dog collar. The electronic collar is managed and controlled with a mobile device or smartphone based application and user interface. The electronic dog collar utilizes Bluetooth, Wi-Fi, GPS, or indoor positioning technology and may contain an ultra-wide band radio transceiver to communicate with a plurality of fixed base stations with ultra-wide band radio transceivers. The fixed base stations measure the signal strength of the electronic dog collar ultra-wide band transceiver and determine the distance to the dog collar. The distance to the dog collar from a plurality of fixed base stations is compared by the invisible leash electronic dog collar system mobile device or smartphone application to triangulate the location of the dog collar. The location and distance to the dog collar may also be determined by the dog owner's mobile device with Bluetooth or Wi-Fi signal ranging and measurement, or alternatively with GPS signals. The electronic collar or collar attachment introduces stimulus, such as a vibration or electric shock, to discourage bad behavior and prevent the dog from going beyond the user-defined radius, home space, or local area map. The mobile device or smartphone based application is provided to display the dog's location information and allow the dog owner to wirelessly connect to the electronic collar invisible leash system and adjust settings and to define the radius distance, home space, or local area map. The mobile device application provides a training and conditioning program for the owner to develop good behavior in their dog, though learning stimulus patterns and routines, and for learning how to use the electronic collar invisible leash system for confinement to a safe home space and to restrict movement into unsafe areas.

### DESCRIPTION OF THE DRAWINGS

FIG. 1 is a view of the invisible leash electronic dog collar system for training a pet dog to stay within a user-defined radius with a mobile device application user interface and an electronic dog collar with network connectivity.

FIG. 2 is a close-up view of the invisible leash electronic dog collar system, with detailed views of the electronic dog collar module, the mobile device application user interface, and network connectivity.

FIG. 3 is a view of the invisible leash electronic dog collar system showing the mobile device application user interface for defining a home space area, the variable stimulus modalities and intensities (i.e., audible, vibrational, and electro-shock), and a view of a home space area and boundaries as defined by the dog owner.

FIG. 4 is a view of the invisible leash electronic dog collar system showing the mobile device user interface, unique user profiles, unique dog profiles, user-defined radius settings, variable stimulus modalities and intensities (i.e., audible, vibrational, and electro-shock), and a detailed view of the user-defined radius overlay on a local area map.

FIG. 5 is a view of the invisible leash electronic dog collar system mobile device sliding scale graphical user interface with the “Radius” slider button, incremental distances, and setting represented with a horizontally moveable slide-able dot or thumb point.

FIG. 6 is a view of the user defining a home space or local area map boundary with the mobile device application user interface with the user drawing and boundary lines in the application.

FIG. 7A is a view of the invisible leash electronic dog collar system mobile device user interface settings menu options, functionality, user profiles, pet profiles, connectivity, and device location.

FIG. 7B is a view of the invisible leash electronic dog collar system mobile device user interface settings menu options, functionality, set home area, corrective settings, safety features, help features, and rewards-based training guide.

### DETAILED DESCRIPTION

The present invention described here is an invisible leash electronic dog collar system which may be embodied as an electronic dog collar with an integrated electronic module with hardware and software for network connectivity, location and indoor positioning technology and the ability to provide variable stimulus modalities and intensities. An alternative embodiment form factor of the electronic dog collar invisible leash system may be a dog collar attachment that attaches to the dog's existing collar. The dog owner attaches the electronic collar or collar attachment to the dog and then proceeds to connect to the collar through a mobile device or smartphone application based user interface. The wireless connection to the electronic dog collar module may be made through Wi-Fi, Bluetooth, or other wireless networking technology protocols. Upon connecting to the module, the dog owner can define the maximum allowable distance or radius to which the dog is permitted to travel away from the owner or mobile device. For example, the dog owner may set the distance radius to 10 feet, 25, feet, 50 feet or 100 feet in the mobile device application user interface.

The dog collar may be constructed with nylon fabric, nylon webbing material, leather or other natural or synthetic fibers with the electronic module hardware contained within a plastic weatherproof enclosure. The collar is adjustable to fit the dog. The electronic module contains computer hardware which may be embodied in a system on a chip (SoC) design, a microcontroller design, or a processor (CPU), memory (RAM, DRAM, SRAM), storage space in the form of flash memory or other non-volatile media (Flash, ROM), with an integrated rechargeable power supply, and may include at least one USB port, a micro USB port, or other peripheral device port which may be used to charge the integrated rechargeable power supply. A network interface is provided with hardware for Wi-Fi connectivity. Additionally, cellular network connectivity may be provided with GSM, CDMA, or 4G LTE hardware. Bluetooth hardware is provided to enable connectivity and pairing with a large number of available mobile or smartphone devices. A receiver is additionally available in the hardware for receiving a signal from the Global Positioning System (GPS). An ultra-wide band radio transceiver is provided so that the electronic dog collar module can be accurately and precisely located during use. Alternative radio transceivers may be used to enable indoor positioning system capability. The hardware may be controlled by embedded software, a real time operating system, or firmware written for the specific electronic dog collar module. Alternatively, the hardware may run an open-source operating system built with a Linux kernel and various free software packages. Still alternatively, the electronic dog collar hardware may run a proprietary operating system such as Windows Embedded Compact, Windows CE, or Android.

The electronic dog collar module additionally includes hardware for providing various stimulus modalities and intensities to the dog. The electronic module plastic waterproof enclosure includes at least one or more electrodes that make contact with the dog for providing electrical shock stimulus. The electrodes are wired to a DC high voltage generator, inverter transformer, or other high voltage electrostatic generating module. The amount of high voltage intensity is variable with a solid-state semiconductor MOSFET switch. The vibrational stimulus modality is provided with an small DC voltage vibrational motor. Audio stimulus may be provided with audio piezo transducer, electroacoustic transducer, or other loudspeaker device. Two-way communications are provided with a microphone and a loudspeaker. Visual stimulus may be provided with LED lights.

To enable indoor positioning system technology, a base station for use with the invisible leash electronic dog collar system may be embodied in an physical enclosure with hardware and software for transmitting and receiving an ultra-wide band radio signal. Alternative radio transceivers may be used to enable indoor positioning system capability. A preferred embodiment of the base station may be a plastic weatherproof enclosure with an ultra-wide band radio transceiver, a network interface device (Wi-Fi or Ethernet connectivity), and microcontroller, system on a chip (SoC), or computer architecture such as a processor (CPU), memory (RAM), and storage space (Flash, or ROM). The base station may include at least one USB port, a micro USB port, or other peripheral device port and include an LED status light to indicate operation status and network connectivity. The base station may be powered by an integrated rechargeable battery pack, or by a conventional household 120-volt wall outlet, or by solar power.

The mobile device or smartphone application for use with the invisible leash electronic dog collar system may be embodied in a freely available and downloadable iPhone, Android, or Windows Mobile application. The dog owner will use his or her mobile device or smartphone to download and run the invisible leash electronic dog collar system application and user interface. The application and user interface allow the dog owner to configure the system settings; to adjust the variable stimulus modalities and intensities; to define the radius distance, home space, or local area map boundaries; and to train and condition the dog with the system.

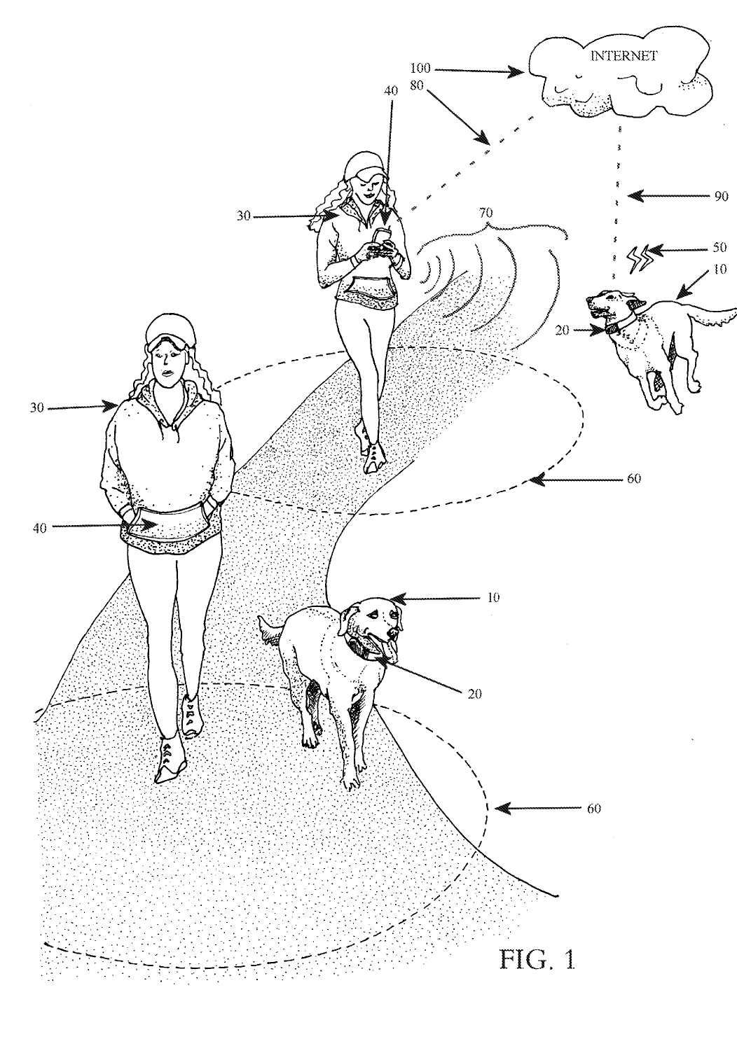

FIG. 1 is view of the dog owner 30 with a mobile device or smartphone 40 running the invisible leash electronic dog collar system application. The dog 10 is wearing the electronic dog collar module 20 and being trained to stay within a user-defined radius 60. The dog owner 30 is able to wirelessly connect to the electronic dog collar module 20 with her mobile device 40 with Bluetooth or Wi-Fi connectivity 70. The mobile device 40 is connected to the network 100 over a CDMA, GSM, or 4G LTE signal 80. The internet 100 provides connectivity between the electronic dog collar module 20 and the mobile device 40. The electronic dog collar module 20 may receive and send data to the dog owner's mobile device 40 over Wi-Fi/Bluetooth 70, or CDMA, GSM, or 4G LTE connectivity 80, 90, 100. The dog 10 is being trained with an electro-shock stimulus 50 to stay within the user-defined radius 60. As the dog owner 30 walks along the path, the system continuously updates, moves and adjusts the user-defined radius 60 to follow the dog owner 30 in response to the owner's changing position.

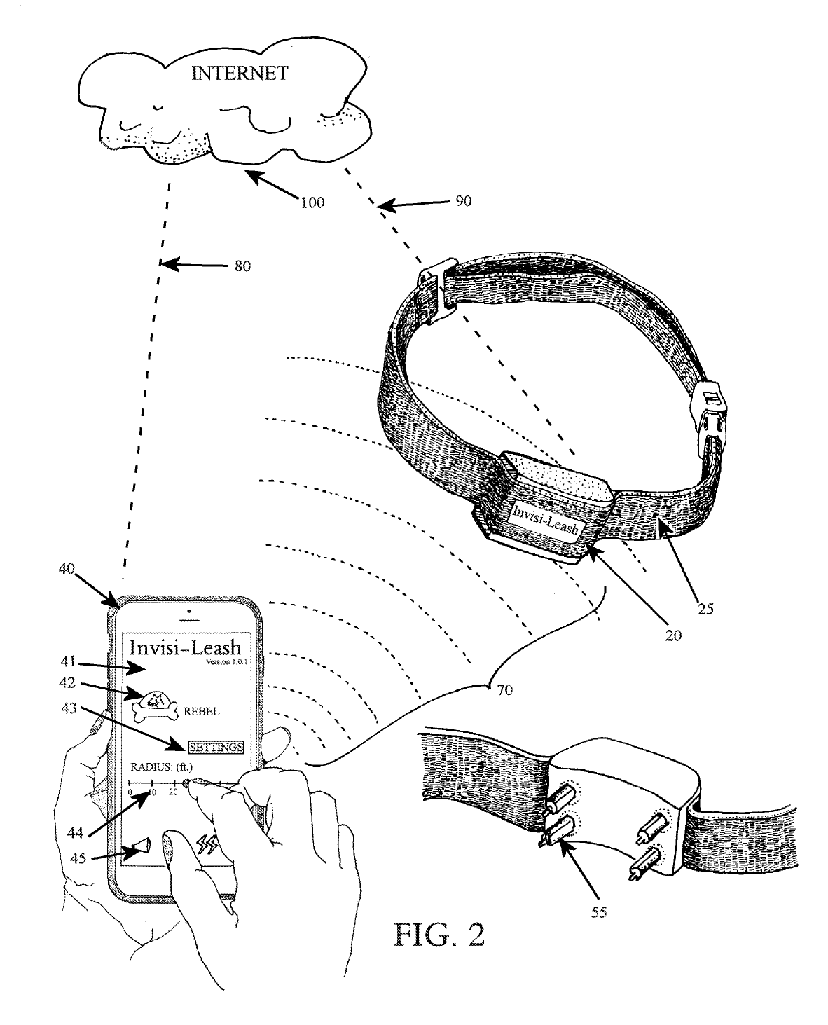

FIG. 2 is a view of the electronic dog collar module 20 and integrated collar 25. The mobile device or smartphone 40 is running the invisible leash electronic dog collar system application and user interface 41. The unique dog profile for “REBEL” 42 is configured with settings 43 and a user-defined radius distance 44 with variable stimulus modalities and intensities 45, i.e., audible, vibrational and electro-shock. The mobile device or smartphone 40 is connected to the network 100 over CDMA, GSM or 4G LTE signal 80. The mobile device or smartphone 40 may be paired with the electronic dog collar module 20 with Bluetooth or Wi-Fi connectivity 70 and additionally may connect with the network 100 over CDMA, GSM or 4G LTE signal 90. The electronic dog collar module 20 is provided with electrodes 55 to enable electrical stimulus to the dog.

In an preferred use case scenario of the invisible leash electronic dog collar system, the dog owner may attach the electronic dog collar module to the owner's dog and go for a walk. The dog owner defines the radius distance in the mobile device running the invisible leash system application user interface. For example, the radius distance may be set to 25 ft. with the “Radius” slider button horizontally moveable slide-able thumb point in the user interface. The dog will then be confined to this pre-set user-defined distance during the walk. As the dog owner traverses a path, the system will track the dog owner's position and continuously update the user-defined radius and shift the boundary to follow the dog owner in response to the owner's movement. The dog will be trained to stay within the user-defined radius by variable stimulus modalities and intensities provided by the electronic dog collar module. For example, the dog may be stimulated with vibrational or electro-shock stimulus to encourage staying near the owner within the user-defined radius during the walk. In this regard, the system functions as an invisible leash to train the dog to stay near the owner while the owner is moving about on a walk.

In an embodiment of the invisible leash electronic dog collar system, the dog collar module is provided with hardware and software to utilize indoor positioning technology in order to determine the precise location of the dog collar down to an acceptable accuracy and resolution for the effective containment and control of the animal's movement. A preferred embodiment of the indoor positioning system as applied to the electronic dog collar may be a plurality of home base stations with integrated ultra-wide band transceivers and a dedicated indoor positioning ultra-wide band transceiver module integrated into the electronic dog collar module for determining the precise radius or distance of the electronic collar from a predefined location or the dog owner. Alternative radio transceivers may be used to enable indoor positioning system capability. Utilizing multiple base stations with the indoor positioning system ultra-wide band transceiver in the electronic dog collar will increase the accuracy and range of the system and ultimately allow triangulation of the dog's precise location. With the predefined radius or distance as setup by the dog owner in the mobile device or smartphone application user interface, the electronic dog collar system is then able to track and determine the distance the dog is currently located at in relation to the a predefined location or user-defined area boundaries using indoor positioning technology.

The invisible leash electronic dog collar system may be setup and configured by the owner by physically distributing multiple base stations around the area in which the owner desires to use the system. For example, if the owner wishes to set a perimeter around his or her living room, bedroom and backyard area, the owner shall distribute multiple base stations throughout the home space area. The owner may place a base station in a corner of the living room and such base station may be powered by a wall outlet. Another base station may be placed in the kitchen and powered by a wall outlet. An additional base station may be set in the bedroom, which may be powered by integrated rechargeable power supply. And yet additional base stations may be placed in the owner's backyard or front yard areas and powered by solar, rechargeable power supplies, or wall outlets. The base stations have integrated ultra-wide band transceivers for ranging the distance from the fixed base station to the electronic dog collar, which has its own ultra-wide band transceiver module. The invisible leash electronic dog collar system is constantly and in real time transmitting and receiving ultra-wide band radio signals to the multiple base stations or network of base stations and triangulating the exact location of the electronic dog collar module within the home space or local map area. The location information of the electronic dog collar is sent to the dog owner's mobile device or smartphone by Wi-Fi, Bluetooth, or other network connectivity.

In determining the location of the dog, the invisible leash electronic dog collar system may use triangulation of the network of base station signals. In a preferred embodiment of the location or position determination methodology, the dog is wearing the electronic dog collar module which is ranging ultra-wide band radio waves or signals to the distributed network of multiple base stations. A first base station measures the signal strength of the ultra-wide band transceiver in the electronic dog collar module and determines or ranges the distance of the collar from the first base station. A second base station measures the signal strength of the ultra-wide band transceiver in the dog collar and determines or ranges the distance of the collar from the second base station, and furthermore a third base station measures the signal strength of the transceiver in the dog collar and determines or ranges the distance of the collar from the third base station. The distance information and data from the first, second and third base stations are provided to the dog owner's mobile device or smartphone though Wi-Fi, Bluetooth, or other network connectivity. The invisible leash electronic dog collar system then triangulates the location of the electronic dog collar method by comparing the distance information and data from the first, second and third base stations. In a preferred embodiment, the mobile device or smartphone application receives the distance information and data from the first, second and third base stations and computes the location of the electronic dog collar. The mobile device or smartphone application user interface displays the location of the dog to the dog owner. Additional base stations may be used to expand the spatial coverage and range of the system, to use the system over a larger area, and to increase location accuracy.

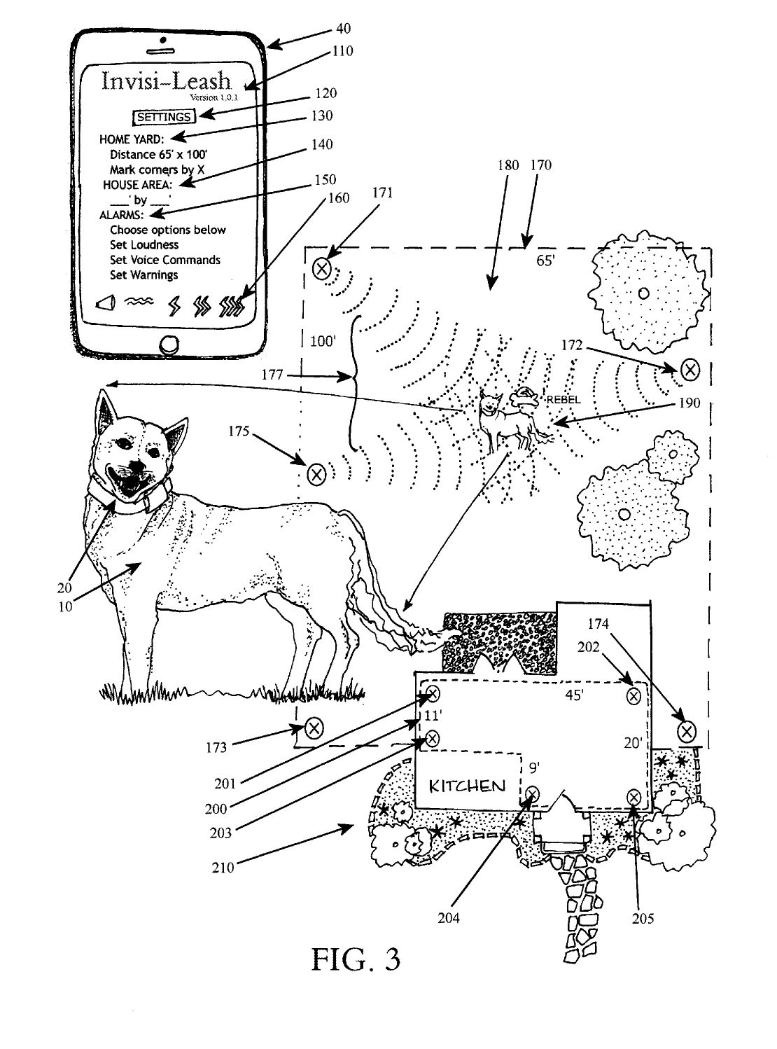

FIG. 3 is a view of the invisible leash electronic dog collar system application 110 running on a mobile device or smartphone 40. The settings 120 are accessed to configure the user-defined home space. The “HOME YARD” 130 and “HOUSE AREA” 140 distance and spatial parameters are setup by the user. The “ALARMS” 150 may be configured for displaying and generating notifications on the user's mobile device or smartphone. The variable audible, vibrational, and electrical stimulus modalities and intensities 160 may also be configured. The dog 10 is wearing the electronic dog collar module 20 and being trained to stay within the user-defined backyard boundary lines 170. The dog's location is determined by ranging the Bluetooth or Wi-Fi signal strength between the dog collar module and the dog owner's mobile device or smartphone 40. Alternatively, the dog's location may be triangulated with multiple distributed base stations 171, 172, 175 that utilize indoor positioning system technology. The wireless radio transceiver signal strength 177 is measured from the electronic dog collar module 20 by the distributed base stations 171, 172, and 175 to triangulate the dog's location. Additional base stations 173, 174 may be used to increase the range and accuracy of the system and define the backyard area 180 and the boundary line 170. Upon crossing the boundary line 170, the dog 10 is given an audible, vibrational or electrical stimulus 160 through the electronic dog collar module 20. The system is used here to train and confine the dog 10 to stay within the backyard area 180 and not enter the front yard 210. Additional base stations 201, 202, 203, 204, and 205 may be distributed within the dog owner's home for defining a home space area 200 for training and confining the dog 10 with the electronic dog collar module 20 and the mobile device application 110.

In setting up the invisible leash electronic dog collar system, the dog owner may distribute base stations near and around the perimeter of a desired home space or local area map in which he or she wishes to confine a pet dog. The dog owner may place multiple base stations in and around the home, front yard and backyard areas. In order to define the boundary lines of the home space or local area map, the dog owner may set the system in user-defined boundary mode, and physically carry the electronic dog collar module along the preferred boundary lines. In a preferred embodiment of this setup, the dog owner sets the invisible leash electronic dog collar system in user-defined boundary mode through the mobile device or smartphone application user interface. The dog owner then carries or walks the electronic dog collar module along the preferred boundary lines of the home space or local area map. This way the dog owner “draws” the boundary lines of the desired area by manually walking along the boundary lines. The system will acquire the location information and data from the network of distributed base stations and compute the location of the boundary lines as defined by the dog owner. For example, each base station will receive and range an ultra-wide band transceiver signal from the dog collar module, measure the signal strength, and compute distance information. The distance and ranging data from multiple base stations will be compared and the location of the dog collar module will be determined during the walk along the user-defined boundary. The location information and data of the boundary lines is stored in the system for use in mapping the home space or local area map and ultimately used to determine the dog's location with respect to the user-defined boundary lines.

In an alternative embodiment, the electronic dog collar module utilizes Bluetooth or Wi-Fi to estimate the distance the dog collar is located in relation to the dog owner's mobile device or smartphone. This approach is an alternate available method for determining the radius or distance of the dog from the owner and the information may be used to appropriately alert the owner and correct the dog's behavior though the use of variable stimulus modalities and intensities. Additionally, this approach with using Bluetooth or Wi-Fi signal ranging does not require the use of fixed base stations or other additional hardware.

For example, the dog owner may set the distance that the dog is allowed to travel away from the owner and set the appropriate stimulus modality and intensity to be applied through the mobile device application user interface. The dog owner accesses the mobile device application user interface, selects Bluetooth ranging, and interacts with a “slider” button to set the distance for the dog collar at 50-feet. The slider button may be embodied in a horizontal sliding scale graphical user interface button. The “Radius” slider button may show the available distance setting from 0-100 feet along the horizontal sliding scale, with increments at every 10 feet, and the actual setting represented with a horizontally moveable round slide-able dot or thumb point. The color of the horizontal scale may be varied on either side of the thumb point to increase contrast and readability. The slider button in the user interface may be set from 0-100 feet. The dog owner selects that a mild electrical shock shall be applied when the dog collar approaches the 50 foot radius boundary and a firm electrical shock when the dog collar reaches the 100 foot distance. The dog owner may additionally set up automatic notifications and alerts to be displayed on the mobile device when the dog reaches the predefined distance boundaries. The electronic dog collar module will range its distance with the dog owner's mobile device with a Bluetooth signal to determine the dog's location.

In an alternative embodiment, the invisible leash electronic dog collar system may utilize Wi-Fi signal strength ranging in determining the distance or location of the dog collar. This approach does not require the use of base stations and simply requires a mobile device or smartphone being paired with the electronic dog collar. In this use case scenario, the dog owner accesses the mobile device user interface and selects Wi-Fi signal ranging. The dog owner then sets the distance and appropriate stimulus modalities and intensities, i.e., at 25 feet apply a vibrational stimulus, at 50 feet apply a mild electrical shock, and at 100 feet apply a full electrical shock and send notifications and alerts to the dog owner's mobile device. With this configuration, the dog owner is free to allow his or her dog to roam about without requiring constant attention. The dog will be safely confined to the dog owner's immediate area with the invisible leash electronic dog collar system applying the appropriate stimulus in response to the dog's location being determined with Wi-Fi signal strength ranging, and the dog will be kept within a safe distance or home area.

In another alternative embodiment, the electronic dog collar module utilizes GPS signal technology to estimate the distance the dog collar is located in relation to the dog owner's mobile device, smartphone, or other predefined location point. In this scenario, the electronic dog collar determines whether the module is within the predefined distance radius as set by the user in the mobile device or smartphone application based user interface. Although not as accurate as indoor positioning technologies, the GPS signal approach is an alternate available method for determining the location of the electronic dog collar module in relation to the dog owner's mobile device or smartphone and then applying the appropriate alert to the owner and correcting the dog's behavior and location with effective stimulus modalities and intensities.

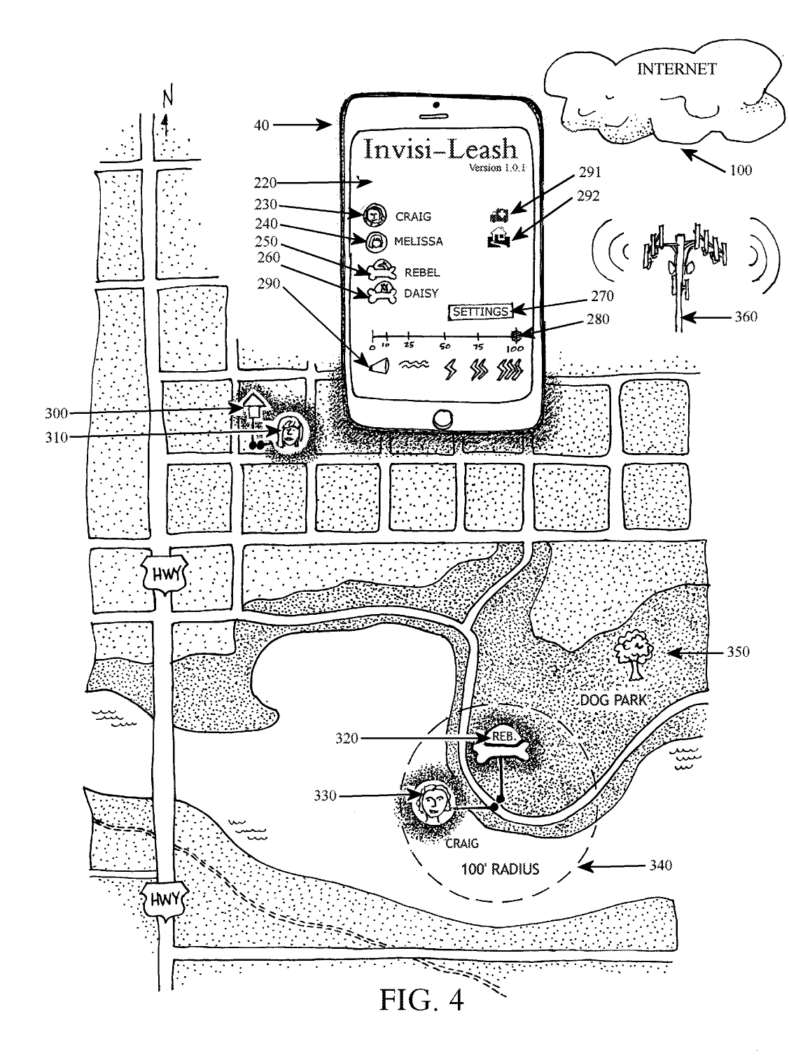

FIG. 4 is a view of the invisible leash electronic dog collar system being used in an outdoor area or dog park 350. The dog owner's mobile device or smartphone 40 is running the system application user interface 220, displaying unique user profiles 230 and 240, and unique dog profiles 250 and 260. The system application may save and store settings for multiple unique user or dog profiles. The settings 170 may be adjusted an configured for each profile. The horizontal slider moveable thumb point 280 may be adjusted to define the radius of the distance to train and confine the dog. The radius is defined as a “100′ RADIUS” 340. Audible, vibrational, or electrical stimulus modalities and intensities 290 are configured in the user interface and may correspond to the radius distance 280. The application user interface may display the local area map of the “DOG PARK” and surrounding areas with overlays for the home location 300, dog owner location 310 and 330 and the dog's location 320. The dog's location 320 is determined with GPS or Bluetooth/Wi-Fi signal ranging. The electronic dog collar module and the mobile device 40 are connected to the network 100 through CDMA, GSM or 4G LTE connectivity 360.

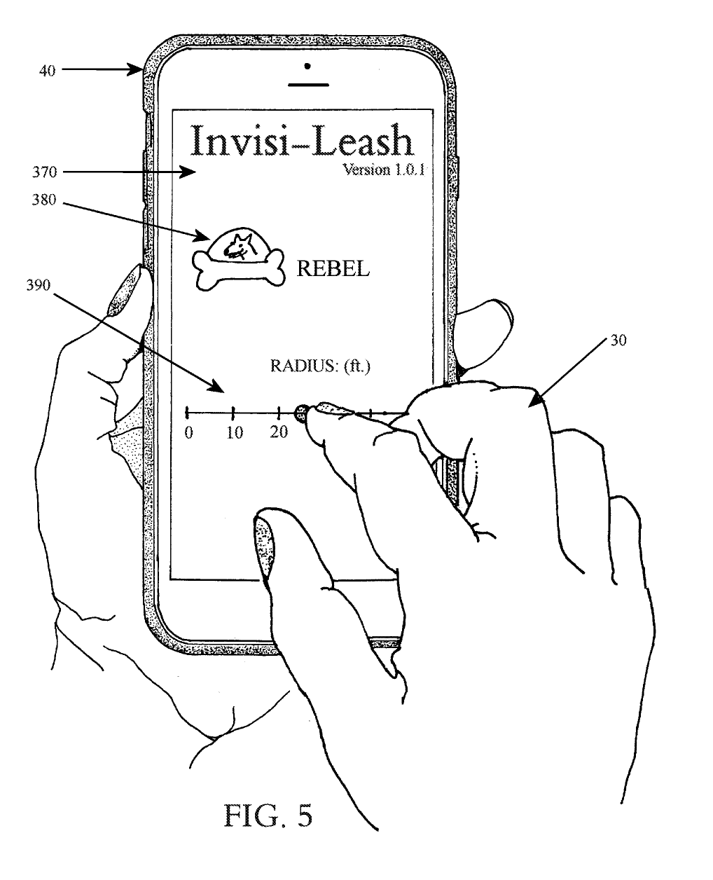

FIG. 5 is a view of the mobile device sliding scale graphical user interface with the “Radius” slider button, incremental distances, and setting represented with a horizontally moveable slide-able dot or thumb point 390. The mobile device 40 is running a version of the invisible leash electronic dog collar system application software 370 and the user 30 is accessing a unique dog profile 380 to configure the radius distance setting 390.

The invisible leash electronic dog collar system is scalable for use with multiple dogs. If the dog owner has two, three or more dogs, each dog may be properly equipped with an electronic dog collar module and trained to stay within a user-defined space or home area. For example, the dog owner may access the mobile device use interface, and pull up the dog profile for “REBEL” and adjust the distance and stimulus setting for that dog. Additional profiles may be accessed in the system user interface. For example, dog profiles may be set for “DAISY”, or “DOG_NAME_1”, or “DOG_NAME_2”, etc. Each dog profile may be configured with unique settings for that dog. Alternatively, the user interface may allow global settings to be applied across multiple dog profiles. For example, the dog owner may wish to set all three dog profiles in the system to be confined to a 100-foot radius and set the appropriate stimulus to be applied. Furthermore, the user interface supports multiple dog owner profiles to save and store settings for different users. For example, the system may save and access settings for “CRAIG”, or “MELISSA”, or “PROFILE_1”, “PROFILE_2”, etc.

With the use of either of the previously described location determination technologies, the invisible leash electronic dog collar system will then apply effective stimulus modalities and intensities to the dog in order to correct and control the animal's location and behavior. For example, if the system determines that the dog has traveled outside and beyond the predetermined radius or distance as set by the dog owner, the electronic dog collar may apply an electrical shock stimulus to stop and arrest the animal's movement. An effective use-case scenario of this type of electro-shock stimulus would be when the dog moves out of the predefined distance or radius and begins traveling into a harmful area such as a busy city street with heavy traffic. In order to prevent the animal from going into harm's way and possibly being injured or killed, the invisible leash electronic dog collar system will effectively apply an electrical shock stimulus to stop and arrest the animal's movement and prevent the dog from traveling into the unsafe area.

In an alternative use-case scenario, the dog owner may set the stimulus modality in the mobile device or smartphone application user interface to apply a vibrational stimulus in response to the dog's movement. For example, if the dog begins traveling into an area that is typically off limits to the dog, but otherwise not highly dangerous or harmful to the animal's well-being, then the electronic dog collar module will politely remind the dog not to go into said area though the delivery of a mild vibrational stimulus. In another alternative example, and depending on the dog's unique training and conditioning, the invisible leash electronic dog collar system may deliver an alternative stimulus modality in the form of an audible cue, clicking, or beeping sound. For example, upon beginning use of the invisible leash electronic collar system, the owner will be required to train the dog to understand the stimulus modalities and intensities as applied by the dog collar module. During training, the owner may wish to utilize audible clicking sounds (i.e., B. F. Skinner clicker training) in order to effective train and condition the dog to understand which behavior is acceptable to the owner.

As the mobile device or smartphone application based user interface allows the dog owner to define the distance or radius to which the dog is permitted to travel (i.e., radius/distance at 10 feet, 25, feet, 50 feet or 100 feet, etc.), an additional feature of the invisible leash electronic dog collar system allows the dog owner do define a home space. In the mobile device or smartphone application user interface, the dog owner selects the “HOME_SPACE” submenu. In the home space menu, the dog owner is provided with a map overview of the dog owner's current location. The owner may draw on the map the unique home space area into which the dog is to be confined. The mobile device or smartphone application then interprets the electronic dog collar's location in relation the predefined home space. If the dog travels outside of the home space area, the dog is provided with various stimulus modalities and intensities in order to correct the animal's behavior and confine the dog to the predefined home space. The dog's location within the home space is determined with a distributed network of ultra-wide band radio transceivers, or other indoor positioning system technology, in order to provide acceptable accuracy and resolution to appropriate limits. Alternatively, Wi-Fi or Bluetooth signal strength ranging, or GPS may be used to approximate the electronic dog collar location in relation to the predefined home space.

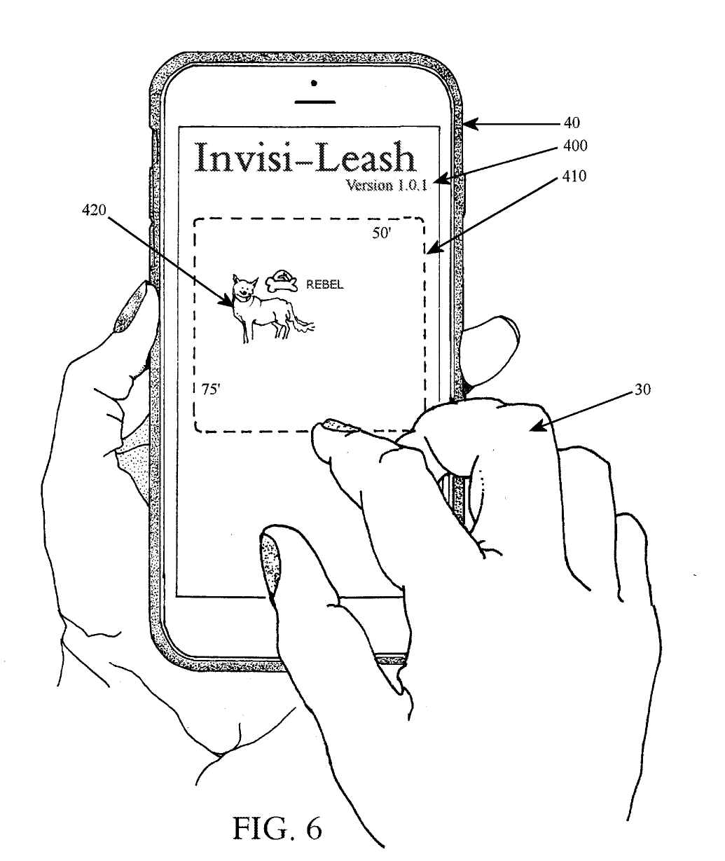

FIG. 6 is a view of the user-defined boundary functionality in the mobile device application user interface 400. The user 30 is defining a home space or local area map boundary 410 by drawing the boundary lines in the application. The user may “draw” on the mobile device application user interface with his or her hand a rectangular, square or other shaped boundary line 410 to train and confine the dog. The dog's location 420 is displayed on the mobile device 40.

In an alternative embodiment of the predefined area settings of the invisible leash electronic dog collar system, the dog owner may access a submenu in the mobile device or smartphone application user interface titled “LOCAL_AREA_MAP”. In the local area map submenu, the dog owner is provided with a larger more broad mapping area than compared with the home space menu. The local area map setting is intended to provide the dog owner with confinement functionality for large outdoor open areas. The dog owner then defines the unique local area map boundaries by drawing on the map menu in the mobile device or smartphone application user interface. Alternatively, the dog owner may define the radius distance with the slider button horizontal sliding scale graphical user interface. With a distributed network of multiple fixed base stations with ultra-wide band radio transceivers, the local area map boundaries may be defined in large outdoor open areas. Alternatively, the local area map may be defined with GPS. Through the definition of a local area map and the provision of multiple ultra-wide band radio transceiver base stations or GPS signals, the dog owner may use the mobile device or smartphone based application and electronic dog collar system to track and locate the dog within a large remote outdoor area. The dog's movement and travel outside of the predefined local area map may be restricted and corrected with the use of variable stimulus modalities as applied with the electronic dog collar module.

In another alternative embodiment of the predefined area settings of the invisible leash electronic dog collar system, the dog owner may access a submenu in the mobile device or smartphone application user interface titled “MANUAL_DEFINE”. In the manual define submenu, the dog owner is prompted to use the electronic dog collar module to manually define the home space or local area map by using the dog collar itself to draw the map area boundaries. In this setup procedure, the mobile device or smartphone application user interface prompts the dog owner to begin traversing or walking the boundary lines of the desired home space or local area map with the dog collar module in hand. For example, in the manual define setup mode, the dog owner walks the boundary lines of his or her home property with the dog collar module. The distributed network of fixed base stations with ultra-wide band radio transceivers, GPS, Bluetooth, or Wi-Fi provides ranging and location data to the system. The mobile device or smartphone application user interface will acquire and track the location of the dog collar during the walk and store and define the location points and boundaries of the dog owner's property. This location data is then stored in the mobile device or smartphone application user interface program and used to define the home space of the dog owner for confining his or her dog with the invisible leash electronic dog collar system.

In a further alternative embodiment of the predefined area settings of the invisible leash electronic dog collar system, the dog owner may access a submenu in the mobile device or smartphone application user interface titled “DOG_DEFINE”. In the dog define submenu, the dog owner uses and relies on the dog's current actual position to store and define location points for the accumulation of location data for use in defining a home space or local area map. In this setup procedure, the mobile device or smartphone application user interface prompts the dog owner to acquire and store location data while the dog is traversing the home space or local area map boundary limits in real time. When the dog reaches a desired boundary location point, the dog owner then selects to store the location data in the mobile device or smartphone application user interface. For example, upon reaching a maximum allowable distance from a home location point, the dog owner may store the dog's location data in the application for determination of the confinement boundary area. Multiple location points may be defined in this manner to develop a set of location points for defining a home space or local area map with the dog's electronic collar location information. A distributed network of fixed base stations with ultra-wide band transceivers or other indoor positioning system technology provides distance and ranging data to the system for the determination of the dog's location. Alternatively Bluetooth, Wi-Fi, or GPS may be used to determine the dog's location.

The use of an electronic dog collar is not effective unless the dog understands the stimulus. The dog owner is therefore required to provide some amount of training and conditioning to the dog in order to develop association with the stimulus provided by the electronic collar and the corresponding behavior that is being corrected. For example, the dog must be trained to understand that when an electrical shock is being triggered by the electronic collar module that this means that the owner is attempting to arrest or prevent the dog from traveling beyond a predetermined boundary. The invisible leash electronic dog collar mobile device or smartphone application user interface provides a submenu titled, “TRAINING_AND_CONDITIONING”. In the training and conditioning submenu, the dog owner may access a training program for use in developing the dog's recognition of patterns and routines with regard to the variable stimulus modalities and intensities provided by the electronic dog collar module.

For example, the dog owner may access a submenu in the training and conditioning menu titled, “VIBRATION_MARKER”. In the vibration marker submenu, the dog owner is able to train and condition the dog to understand a vibrational marker and associate it with a desired behavior. For example, the dog owner may wish to train the dog to associate the vibration marker with the desired behavior of getting inside the car. In this use case scenario, the dog owner triggers the vibration marker with the mobile device or smartphone application user interface. The vibration stimulus is then applied to the dog through electronic dog collar module. The owner then carries out the routing of coaxing the dog into the car and provides a reward or positive reinforcement for the good behavior. The dog owner is able to establish training success rates by entering whether the task is successful into the mobile device or smartphone application user interface. Over time and through repetition of the pattern of applying the vibration marker, getting the dog to get into the car, and providing reward based positive reinforcement, the dog owner should be able to train and condition the dog to get into the car by simply introducing the vibration marker stimulus. The mobile device or smartphone application user interface will keep track of successful and unsuccessful attempts at getting the dog to perform the desired task and display success rates though the user interface submenus.

In an alternative training and conditioning procedure, the dog owner may access a submenu in the training and conditioning menu titled, “ELECTRO_SHOCK_MARKER”. In the electro-shock marker submenu, the dog owner is able to train and condition the dog to understand an electrical shock marker and associate with a desired behavior. For example, the dog owner may wish to train the dog to associate the electrical shock marker with the undesired bad behavior of running towards a busy street with traffic. When confronted with the bad behavior of the dog running away and into potential danger, the dog owner then accesses the electro shock marker submenu and triggers the electrical shock stimulus on the electronic dog collar module. The dog is then provided an electro-shock stimulus during the observed bad behavior. Over time and through repetition of this pattern, the dog owner will be able to train and condition the dog to stop and discontinue bad behavior with the application of the electro-shock marker. The mobile device or smartphone application user interface will track the user of the marker and provide the dog owner with use data, such as time and date, strength of stimulus, and observed outcome. The mobile device or smartphone application user interface will organize and provide recorded use data of the training and conditioning entries.

In an alternative training and conditioning procedure, the dog owner may access a submenu in the training and conditioning menu titled, “AUDIO_MARKER”. In the audio marker submenu, the dog owner is able to provide an auditory cue, such as a clicking or beeping tone or voice command in order to train and condition the dog to understand the audio marker with a desired behavior. For example, the dog owner may wish to train the dog to understand a pre-recorded audio marker for the sit command. In this training routine, the owner will use the mobile device or smartphone application user interface to activate the “SIT” pre-recorded audio command on the electronic dog collar module. The owner will then take a brief pause, produce a dog treat in hand, and gesture the treat towards and above the dog until the dog enters the sitting position. The mobile device or smartphone application user interface will track the success rate of this training routing and provide the dog owner with useful data analysis. Over time and through repetition, the dog owner will be able to condition the dog to successfully sit upon the activation of the “SIT” command on the mobile device or smartphone application user interface. Additionally, the electronic dog collar provides two-way radio hardware where the dog owner may verbally communicate and talk to the dog through the mobile device user interface. The dog collar relays the owner's verbal commands though an integrated loudspeaker. A microphone is also provide to give the dog owner audio feedback from the dog.

In an alternative training and conditioning procedure, the dog owner may access a submenu in the training and conditioning menu titled, “BOUNDARY_TRAIN”. In the boundary train submenu, the dog owner is provided with training methods and routines for teaching the dog to stay with the user-defined distance radius, home space or local area map. In using the electronic dog collar module to keep the dog within a certain area, the dog owner must first teach the dog to understand and associate the variable stimulus modalities and intensities with the undesired behavior of going beyond the user-defined area boundaries. With a predefined distance radius, home space, or local area map, the dog owner can apply an electrical, vibrational or auditory stimulus to the dog collar when observing the dog reaching the boundary limits of the user-defined area.

In a potential use-case scenario, the dog owner may view the dog's location on the mobile device or smartphone app, and when the dog approaches a boundary line of the user-defined area, the dog owner may then apply the desired stimulus modality and intensity. For example, the owner may see that the dog is approaching the end of the front yard and entering the neighbor's yard. The dog owner can see the dog's location on the mobile device or smartphone application user interface. The dog's location is continuously tracked and updated by system application with location data from the network of distributed fixed base stations with ultra-wide band radio transceivers, or other indoor positioning system technology, or Bluetooth, Wi-Fi, or GPS signals. In the boundary train submenu, the dog owner can select and apply a mild electrical shock to the dog collar to stop and arrest the dog's movement into the neighbor's yard. The user interface will track and store the dog's movement upon activation of the stimulus and provide useful data analysis and statistics to the dog owner. Over time and through multiple uses of the boundary train routine, the dog owner will be able to view the success rate of the stimulus and adjust the intensity in order to improve performance of the system.

The dog owner may configure the system to automatically apply stimulus to the dog when it approaches the user-defined boundary. With the accumulation of location data and stimulus modality and intensity data, the system will be able to correlate the dog's behavior with the provision of stimulus. For example, the dog owner may set the system to “AUTO_CONFINE” mode in the mobile device or smartphone application user interface. In this mode, the system application tracks the dog's location within the home space or local area map and applies a pre-configured stimulus, i.e., electro-shock, vibration, or auditory cue, in order to train and keep the dog within the user-defined boundaries. The system may also provide the dog owner with alerts on the mobile device or smartphone application when the dog breaches the user-defined boundaries and when the dog must be retrieved.

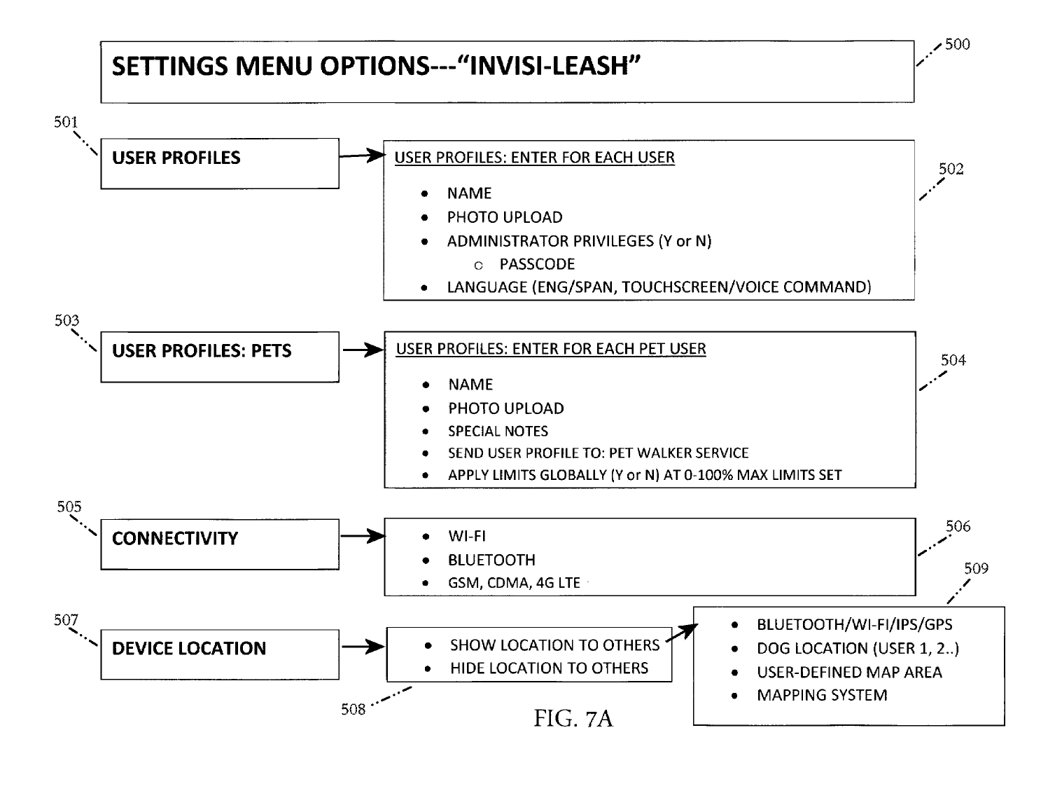

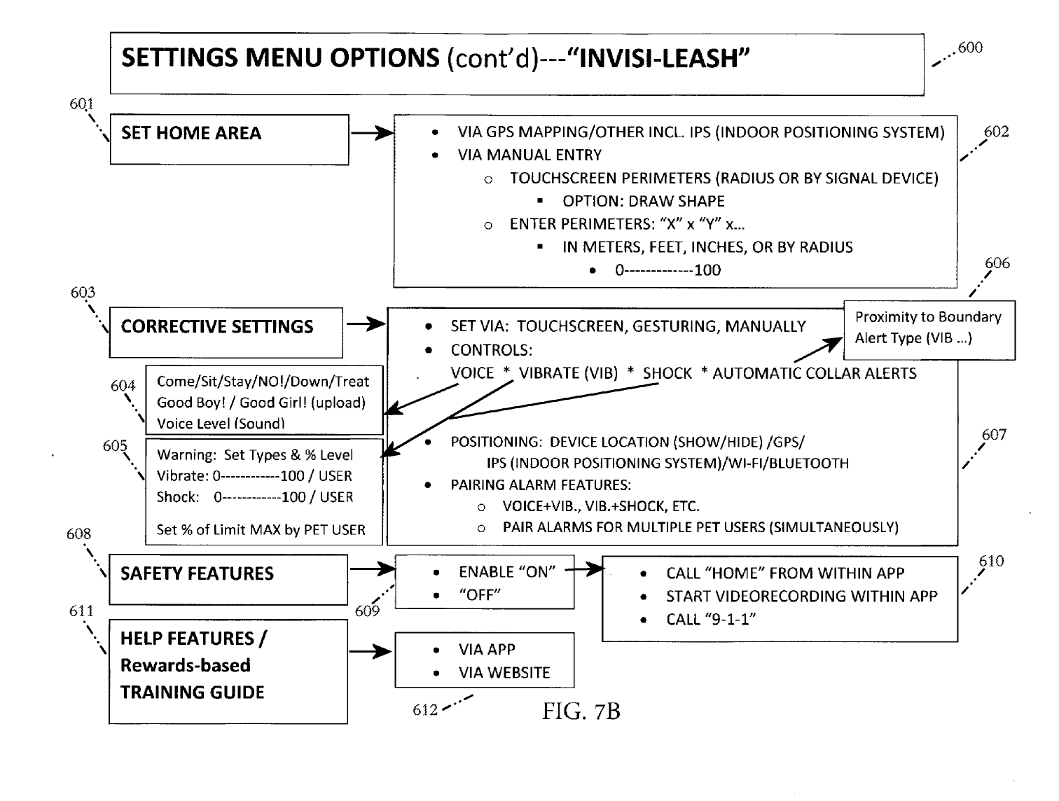

FIG. 7A is a view of the invisible leash electronic dog collar system mobile device user interface settings menu options 500 and functionality of user profiles 501, pet profiles 503, connectivity 505, and device location 507. The system application provides user profiles 501 and settings 502 for name, photo upload, administrator privileges, passcode, and language, with accessibility options for touchscreen or voice command. The user profiles: pets 503 may be configured for each pet user with name, photo upload, special notes, options to send profile to pet walker service, and whether to apply settings globally 504. Connectivity and paring settings 505 may be configured for Wi-Fi, Bluetooth, IPS (indoor positioning system), GPS, or cellular network connectivity over GSM, CDMA, or 4G LTE signals 506. Device location settings and configuration 507 may be accessed for show location to others, or hide location for others 508, with functionality for Bluetooth, Wi-Fi, IPS, and GPS, dog location (user 1, 2, etc.), user-defined map area, and mapping system settings 509.

FIG. 7B is a view of the invisible leash electronic dog collar system mobile device user interface settings menu options 600 and functionality for set home area 601, corrective settings 603, safety features 608, and help features and rewards-based training guide 611. The set home area submenu 601 provides settings for GPS mapping, IPS (indoor positioning system) options, and manual entry where the user to enters the dimensional parameters or “draws” the home area on user interface 602. The units may be adjusted from FEET, to INCHES or by RADIUS. The corrective settings 603 are accessed to provide audible or voice cues where the dog owner may upload his or her voice, or alternatively use pre-recorded voice commands 604 for “COME”, “SIT”, “STAY”, “NO!”, “DOWN”, “TREAT”, “GOOD BOY!”, or “GOOD GIRL!”. The warning settings 605 may be adjusted from a minimum to a maximum level for vibrational or electro-shock stimulus, and be defined per user or pet user profile. Electro-shock stimulus may be adjusted from a minimum to a maximum level, with the minimum, medium, and maximum levels configurable for each dog user profile. Corrective settings submenu 606 and 607 are provided to allow the user to set via the touchscreen, gesturing or by manually entering the values. Alerts may be provided with voice, vibrational or electro-shock stimulus, and further the alerts may be automatic. The alert type may be set for the electronic dog collar module proximity to a boundary 606. Positioning settings for device location, show/hide location, GPS, IPS (indoor positioning system), Wi-Fi, Bluetooth are also configurable in submenu 607. Pairing alarm features for “VOICE+VIBRATE”, “VIBRATE+SHOCK”, or other alarm pairings are also provided. Safety features 608 of the application are adjustable and may be enabled or off 609. The safety features may call home from within the application 610, start a video recording within the application, or call “9-1-1”. Help features and rewards based training guide may be accessed 611 from the system application or from an externally provided website 612.

1. An invisible leash electronic dog collar system for training a dog to stay within a user-defined radius with additional settings and functionality provided through a mobile device application user interface, the system comprising:
an electronic dog collar module with hardware for Bluetooth or Wi-Fi connectivity;
a mobile device; and
a mobile device application and user interface;
wherein the user defines the radius through the mobile device application user interface;
wherein the mobile device ranges the Bluetooth or Wi-Fi signal strength and determines the radius of the electronic dog collar; and wherein the electronic dog collar provides variable stimulus modalities and intensities in response to the dog's radius.

2. The invisible leash electronic dog collar system of claim 1, wherein the user defines the radius distance by accessing and configuring a slider button in the mobile device user interface wherein the slider button comprises a horizontal sliding scale with incremental radius distance markings and a movable thumb point.

3. The invisible leash electronic dog collar system of claim 1, wherein the electronic dog collar module variable stimulus modalities and intensities comprise a high voltage electrostatic generating module; a vibrational motor; a loudspeaker, and a microphone, and wherein the strength of each stimulus may be varied from low to high and correspond to the user-defined radius.

4. The invisible leash electronic dog collar system of claim 1, wherein the system may be used with multiple dogs wherein the user may use the mobile device application user interface to access and configures a unique profile for each dog and apply settings globally across all profiles in the system.

5. The invisible leash electronic dog collar system of claim 1, wherein the user accesses the mobile device application user interface to define a plurality of specific stimulus modalities and intensities to be applied at unique radius distance settings.

6. The invisible leash electronic dog collar system of claim 1, wherein the user may set the mobile device application user interface to display automatic notifications and alerts in response to the dog's radius distance.

7. The invisible leash electronic dog collar system of claim 1, wherein the user defines the distance by manually walking the electronic dog collar along the desired boundary area lines or by drawing the boundary area lines on the map provided in the mobile device application user interface.

8. The invisible leash electronic dog collar system of claim 1, wherein the electronic dog collar module includes an integrated rechargeable power supply with at least one USB port, a micro USB port, or other peripheral device port for charging the power supply.

9. The invisible leash electronic dog collar system of claim 1, wherein the user-defined radius follows and shifts in response to the user's movement.

10. An invisible leash electronic dog collar system for training a dog to stay within a user-defined radius, home space, or local area map with additional settings and functionality provided through a mobile device application user interface, the system comprising:
an electronic dog collar module with network connectivity and a wireless radio transceiver;
a mobile device;
a mobile device application and user interface; and
a plurality of distributed base stations;
wherein the user defines the radius, home space, or local area map boundaries through the mobile device application user interface; wherein the plurality of distributed base stations provide wireless radio transceiver signal strength and ranging information to the mobile device application; and wherein the mobile device application triangulates the location of the electronic dog collar; and wherein the electronic dog collar provides variable stimulus modalities and intensities in response to the dog's location.

11. The invisible leash electronic dog collar system of claim 10, wherein the user defines the radius by accessing and configuring a slider button in the mobile device user interface wherein the slider button comprises a horizontal sliding scale with incremental distance markings and a movable thumb point.

12. The invisible leash electronic dog collar system of claim 10, wherein the electronic dog collar module variable stimulus modalities and intensities comprise a high voltage electrostatic generating module; a vibrational motor; a loudspeaker, and a microphone, and wherein the strength of each stimulus may be varied from low to high and correspond to the user-defined radius, home space, or local area map.

13. The invisible leash electronic dog collar system of claim 10, wherein the system may be used with multiple dogs wherein the user may use the mobile device application user interface to access and configures a unique profile for each dog and apply settings globally across all profiles in the system.

14. The invisible leash electronic dog collar system of claim 10, wherein the electronic dog collar module and plurality of distributed base stations comprise an indoor positioning system to range the signal strength and locate the electronic dog collar module.

15. The invisible leash electronic dog collar system of claim 10, wherein the user defines the home space or local area map boundaries by manually walking the electronic dog collar along the desired boundary area lines or by drawing the boundary area lines on the map provided in the mobile device application user interface.

16. The invisible leash electronic dog collar system of claim 10, wherein the electronic dog collar module includes an integrated rechargeable power supply with at least one USB port, a micro USB port, or other peripheral device port for charging the power supply.

17. The invisible leash electronic dog collar system of claim 10, wherein the user-defined radius, home space, or local area map follows and shifts in response to the user's movement.

18. An invisible leash electronic dog collar system for training a dog to stay within a user-defined, radius, home space, or local area map with additional settings and functionality provided through a mobile device application user interface, the system comprising:
an electronic dog collar module with network connectivity and an integrated ultra-wide band radio transceiver;
a plurality of distributed base stations with network connectivity and integrated ultra-wide band radio transceivers for ranging the signal strength of the dog collar transceiver; and
a mobile device application for connecting to the electronic dog collar module and receiving the signal strength information from the plurality of distributed base stations;
wherein the mobile device application compares the signal strength information from the plurality of distributed base stations, triangulates the location of the dog collar, and displays the location on the mobile device application user interface; wherein the mobile device application user interface allows the provision of user-defined radius, home space, or local area map boundaries; and wherein the mobile device application user interface provides a program to train and condition the dog to stay within the user-defined boundaries by applying variable stimulus modalities and intensities to the dog collar.

19. The invisible leash electronic dog collar system of claim 18, wherein the user defines the radius distance by accessing and configuring a slider button in the mobile device user interface wherein the slider button comprises a horizontal sliding scale with incremental distance markings and a movable thumb point.

20. The invisible leash electronic dog collar system of claim 18, wherein the electronic dog collar module variable stimulus modalities and intensities comprise a high voltage electrostatic generating module; a vibrational motor; a loudspeaker, and a microphone, and wherein the strength of each stimulus may be varied from low to high and correspond to the user-defined radius, home space, or local area map.

21. The invisible leash electronic dog collar system of claim 18, wherein user distributes the plurality of base stations throughout a home space or local map area and wherein the plurality of base stations connect to the network over Wi-Fi or Bluetooth to provide the mobile device application with distance and ranging information of the electronic dog collar module.

22. The invisible leash electronic dog collar system of claim 18, wherein the system may be used with multiple dogs wherein the user may use the mobile device application user interface to access and configures a unique profile for each dog and apply settings globally across all profiles in the system.

23. The invisible leash electronic dog collar system of claim 18, wherein the user defines the home space or local area map boundaries by manually walking the electronic dog collar along the desired boundary area lines.

24. The invisible leash electronic dog collar system of claim 18, wherein the user defines the home space or local area map boundaries by drawing the boundary area lines on the map provided in the mobile device application user interface.

25. The invisible leash electronic dog collar system of claim 18, wherein the electronic dog collar module includes an integrated rechargeable power supply with at least one USB port, a micro USB port, or other peripheral device port for charging the power supply.

26. The invisible leash electronic dog collar system of claim 18, wherein the user-defined radius, home space, or local area map follows and shifts in response to the user's movement.
